(19) United States
(12) Patent Application Publication
(10) Pub. No.: US 2026/0236280 A1
(43) Pub. Date: Aug. 13, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi (JP)

(72) Inventor: Satoshi Naito, Yokohama-shi Kanagawa-ken (JP)

(73) Assignee: TOYOTA JIDOSHA KABUSHIKI KAISHA, Toyota-shi (JP)

(21) Appl. No.: 19/446,366

(22) Filed: Jan. 12, 2026

(30) Foreign Application Priority Data
Jan. 16, 2025 (JP) 2025-006157

(51) Int. Cl. G06F 9/451; B60K 35/10; B60K 35/22; G06F 3/04817

(52) U.S. Cl. CPC G06F 9/453; B60K 35/10; B60K 35/22; G06F 3/04817; B60K 2360/1438

(57) ABSTRACT

Short cut buttons are made to be displayed on the basic screen of the display device. When addition information of a new function or update information of an existing function is received, the short cut button to which the added new function or the updated existing function is assigned is made to be displayed on the basic screen of the display device.

### CROSS-REFERENCE TO RELATED APPLICATIONS

This application claims priority to Japanese Patent Application No. 2025-006157 filed Jan. 16, 2025, the entire contents of which are herein incorporated by reference.

### FIELD

The present disclosure relates to a display control device, display control method, and storage medium.

### BACKGROUND

Known in the art is an information apparatus designed to display vehicle function buttons, that is, short cut buttons, for calling up specific functions relating to operation of a vehicle, on a menu screen of a display device mounted in the vehicle (for example, see Japanese Unexamined Patent Publication No. 2024-49711). This information apparatus is designed to acquire the frequencies of use of the different functions relating to operation of the vehicle separated into use while the vehicle is moving and while the vehicle is stopped, display function buttons, that is, short cut buttons, for calling up functions judged to be high in frequency of use while the vehicle was moving when the vehicle is moving, and display function buttons, that is, short cut buttons, for calling up functions judged to be high in frequency of use while the vehicle was stopped when the vehicle is stopped.

### SUMMARY

In this regard, in recent years, in automobiles, the work of updating software for control of various functions by wireless communications and adding the new functions or updating the existing functions are frequently performed. In this case, among the users, there are users who wish to immediately actively use these added new functions or the updated existing functions. For such users, it can be said to be desirable to be able to immediately display short cut buttons for these added new functions or updated existing functions without causing the user to feel burdened. On the other hand, in the above-mentioned information apparatus, the short cut buttons are displayed, but the short cut buttons are displayed for functions with high frequencies of use, so if the history of use of a function has not been built up to a certain extent, the short cut button will not be displayed. Therefore, there is the problem that a user has to repeatedly perform the burdensome operation for display of the short cut button until the history of use of a function has been built up to a certain extent.

The present disclosure is designed to enable the immediate display of the short cut button for the added new function or the updated existing function when a new function is added or an existing function is updated.

According to the present disclosure, there is provided a display control device for controlling a screen display of a display device mounted in a vehicle, the display control device comprising:

a short cut button display control unit for making short cut buttons be displayed on a basic screen of the display device,

the short cut button display control unit making the short cut button to which an added new function or an updated existing function is assigned be displayed on the basic screen of the display device when acquiring addition information of the new function or update information of the existing function.

Furthermore, according to the present disclosure, there is provided a display control method for controlling a screen display of a display device mounted in a vehicle, the display control method causing a computer to

make short cut buttons be displayed on a basic screen of the display device and

make short cut buttons to which an added new function or an updated existing function is assigned be displayed on the basic screen of the display device when acquiring addition information of the new function or update information of the existing function.

Furthermore, according to the present disclosure, there is provided a storage medium storing a program used for controlling a screen display of a display device mounted in a vehicle, the program causing a computer to

make short cut buttons be displayed on a basic screen of the display device and

make short cut buttons to which an added new function or an updated existing function is assigned be displayed on the basic screen of the display device when acquiring addition information of the new function or update information of the existing function.

It is possible to immediately display a short cut button for an added new function or an updated existing function when a new function is added or an existing function is updated.

### BRIEF DESCRIPTION OF DRAWINGS

FIG. 1 is a top view of a vehicle shown schematically.

FIG. 2 is a view showing a functional configuration of a vehicle.

FIG. 3A is a view schematically showing a basic screen of a display device.

FIG. 3B is a view schematically showing a basic screen of a display device.

FIG. 4A is a view schematically showing a screen of a display device.

FIG. 4B is a view schematically showing a screen of a display device.

FIG. 5 is a view schematically showing a screen of a display device.

FIG. 6A is a view schematically showing a screen of a display device.

FIG. 6B is a view schematically showing a screen of a display device.

FIG. 7A is a view schematically showing a screen of a display device.

FIG. 7B is a view schematically showing a screen of a display device.

FIG. 8 is a flow chart for performing processing for setting functions on/off without using short cut buttons.

FIG. 9 is a flow chart for performing processing for setting functions on/off by using short cut buttons.

FIG. 10 is a view schematically showing a screen of a display device.

FIG. 11 is a view schematically showing a screen of a display device.

FIG. 12 is a view schematically showing a screen of a display device.

FIG. 13 is a flow chart for performing processing for display of the short cut button.

FIG. 14 is a flow chart for stopping the display of the short cut button.

FIG. 15 is a flow chart for stopping the display of the short cut button.

FIG. 16 is a flow chart for stopping the display of the short cut button.

FIG. 17 is a flow chart for performing processing for calculating the frequency of use of a function.

FIG. 18 is a view schematically showing a screen of a display device.

FIG. 19 is a flow chart for performing processing for setting functions on/off by using short cut buttons.

### DESCRIPTION OF EMBODIMENTS

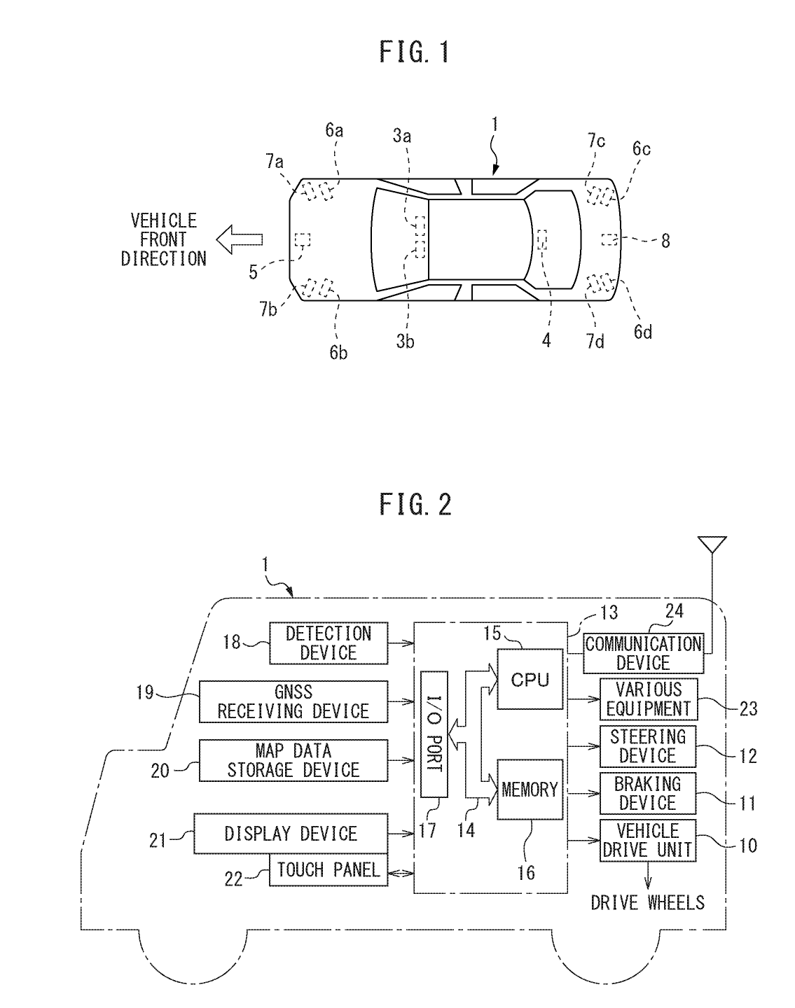

FIG. 1 schematically shows a vehicle 1 when viewed from above, while FIG. 2 shows the functional configuration of the vehicle 1 shown in FIG. 1. Note that, this vehicle 1 can be driven by either manual driving and autonomous driving. If referring to FIG. 2, 10 indicates a vehicle drive unit for imparting drive force to drive wheels of the vehicle 1, 11 indicates a braking device for braking the vehicle 1, 12 indicates a steering device for steering the vehicle 1, and 13 indicates an electronic control unit mounted in the vehicle 1. As shown in FIG. 2, the electronic control unit 13 is comprised of a digital computer and is provided with a CPU (processor) 15, a memory 16 comprised of a ROM and RAM, and an input/output port 17 which are connected with each other by a bidirectional bus 14.

On the other hand, as shown in FIG. 2, in the vehicle 1 , a detection device 18 including various types of sensors required when the vehicle 1 is being manually driven or automatically driven is arranged. This detection device 18 includes sensors for detecting the state of the vehicle 1 and sensors for detecting the surroundings of the vehicle 1. In this case, as sensors for detecting the state of the vehicle 1, an acceleration sensor, speed sensor, azimuth sensor, and geomagnetic sensor are used. As sensors for detecting the surroundings of the vehicle 1, cameras for capturing the areas in front of, at the sides of, and at the back of the vehicle 1, and lidars, radars, clearance sonars, etc. for detecting the areas in front of, at the sides of, and at the back of the vehicle 1 are used.

FIG. 1 shows one example of the sensors arranged in the vehicle 1. In the example shown in FIG. 1, visible light cameras 3a, 3b for capturing the area in front of the vehicle 1, a rear camera 4 for capturing the area in back of the vehicle 1, a long distance millimeter wave radar 5 for emitting millimeter waves toward the area in front of the vehicle 1, medium distance millimeter wave radars 6a, 6b, 6c, and 6d for emitting millimeter waves toward the areas at the sides of the vehicle 1, lidars 7a, 7b, 7c, and 7d for firing laser beams toward the areas at the sides of the vehicle 1, and clearance sonar 8 for emitting ultrasonic waves toward the area in back of the vehicle 1 are arranged in the vehicle 1. Note that, the method of setting the cameras and sensors shown in FIG. 1 shown is just an example. There are various methods for arranging these cameras and sensors.

Returning again to FIG. 2, the vehicle 1 is provided with a GNSS (global navigation satellite system) receiving device 19, map data storage device 20, and display device 21. The GNSS receiving device 19 can detect a current position of the vehicle 1 (for example, the latitude and longitude of the vehicle 1) based on information obtained from a plurality of artificial satellites. Therefore, it is possible to acquire the current position of the vehicle 1 by this GNSS receiving device 19. As this GNSS receiving device 19, for example, a GPS receiving device is used. Further, in the map data storage device 20, the map data etc. necessary for the vehicle 1 to run is stored. The detection device 18, the GNSS receiving device 19, and the map data storage device 20 are connected to the electronic control unit 13.

The display device 21 is arranged inside the vehicle compartment and has a screen able to be viewed by the user of the vehicle 1, for example, the driver of the vehicle 1. A pressure sensitive type, electrostatic inductance type, or electrostatic capacity type thin film shaped touch panel 22 is integrally formed on the screen of the display device 21. These display device 21 and touch panel 22 are connected to the electronic control unit 13. Further, headlights, turn lights, inside compartment lights, an air-conditioner, and other various devices 23 are arranged in the vehicle 1. These various devices 23 are connected to the electronic control unit 13. A communication device 24 for receiving television broadcasts, radio broadcasts, traffic information, etc. and trading signals with information centers or other vehicles is mounted in the vehicle 1. This communication device 24 is connected to the electronic control unit 13.

In the example shown in FIG. 2, the vehicle drive unit 10 of the vehicle 1 is comprised of an electric motor driven by a secondary battery or an electric motor driven by a fuel cell. The drive wheels are controlled in drive by these electric motors in accordance with output signals of the electronic control unit 13. Further, the braking of the vehicle 1 is controlled by the braking device 11 in accordance with output signals of the electronic control unit 13, while the steering of the vehicle 1 is controlled by the steering device 12 in accordance with output signals of the electronic control unit 13.

First, the meanings of the terms used in this Description will be simply explained.

In this Description, “power on” indicates “a state where the vehicle 1 can be controlled in drive” while “power off” indicates “a state where the vehicle 1 cannot be controlled in drive”.

Further, in this Description, “function on” indicates “a state where a function is activated or a state where a function can be activated” while “function off” indicates “a state where a function is deactivated”.

Further, in this Description, “a function is set on” indicates “a function is set so that the function is activated” while “a function is set off” indicates “a function is set so that the function is deactivated”.

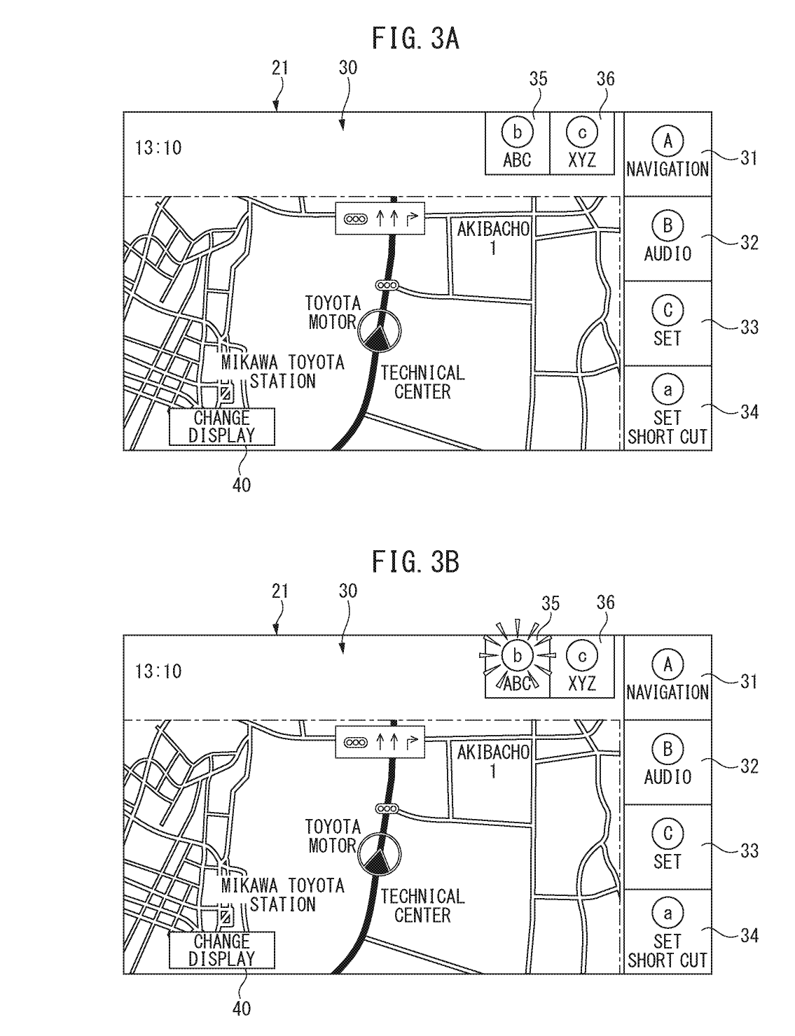

Next, referring to FIG. 3A, the screen 30 of the display device 21 used in an embodiment according to the present disclosure will be explained. If the display device 21 is started up, as shown in FIG. 3A, a button 31 for a navigation function which is one of the basic functions, a button 32 for an audio function which is one of the basic functions, and a button 33 for a setting function which is one of the basic functions are displayed on the surroundings of the screen 30 of the display device 21. At this time, as shown in FIG. 3A, for example, a road map is displayed on the screen 30 of the display device 21. In this Description, the screen 30 on which the button 31 for a navigation function which is one of the basic functions, the button 32 for an audio function which is one of the basic functions, and the button 33 for a setting function which is one of the basic functions are displayed like when the display device 21 is started up will be called a “basic screen”.

Note that, in the embodiment shown in FIG. 3A, a layer of the thin film shaped touch panel 22 is formed on the screen 30 of the display device 21. In FIG. 3A, if buttons displayed on the screen 30 such as the navigation function button 31, audio function button 32, and setting function button 33 are touched, the fact of the buttons being touched is recognized by the electronic control unit 13 through the touch panel 22. In this Description, the fact of buttons being displayed on the screen 30 so that the fact of buttons being touched is recognized by the electronic control unit 13 will be referred to simply as the buttons being displayed on the screen 30. Note that, in FIG. 3A, the marks A, B, C and letters illustrate schematically icons showing the navigation function, audio function, and setting function.

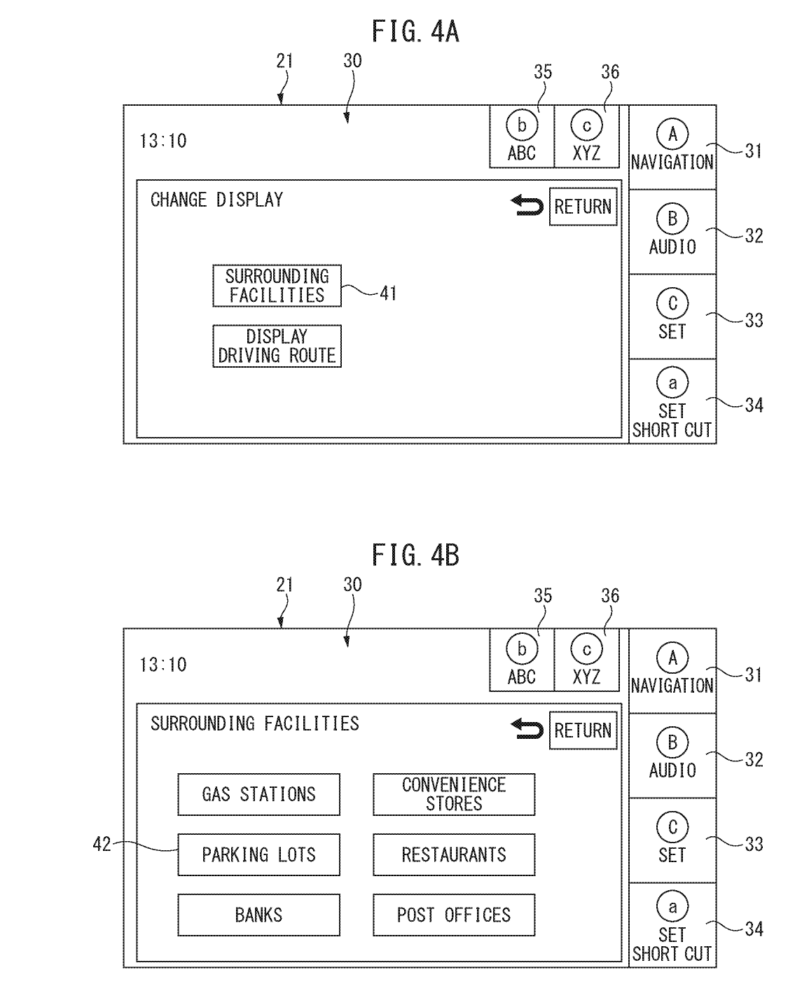

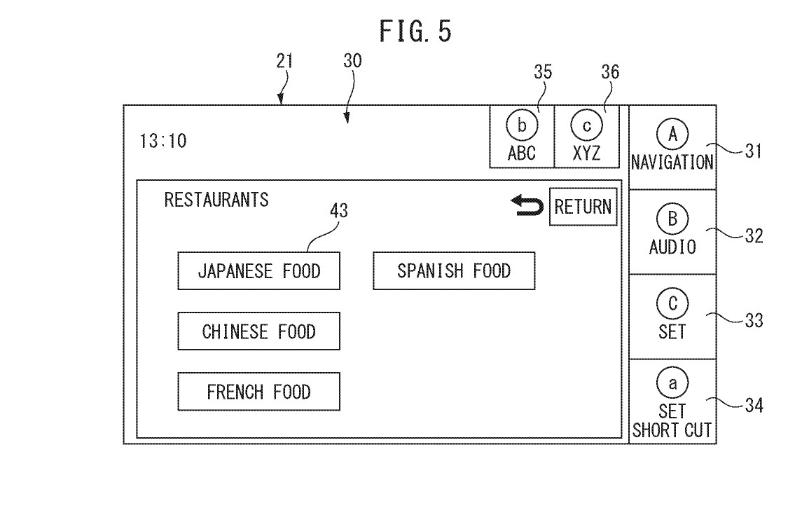

Next, one example of the button operation in these basic functions will be simply explained. FIG. 3A shows the case where the button 31 for a navigation function is touched and a road map is displayed on the basic screen of the display device 21. If a display changing button 40 provided on this road map is touched, the road map is switched to a display changing screen such as shown in FIG. 4A positioned one level lower. Next, if, for example, a surrounding facility button 41 which is displayed on this display changing screen is touched, the display changing screen is switched to a surrounding facility selection screen such as shown in FIG. 4B positioned one further level lower. Next, if, for example, a restaurant button 42 which is displayed on this surrounding facility selection screen is touched, the surrounding facility selection screen is switched to a restaurant selection screen such as shown in FIG. 5 and positioned a further one level lower. Next, if for example a Japanese food button 43 displayed on this restaurant selection screen is touched, the restaurant selection screen is switched to the road map screen shown in FIG. 3A and the positions of Japanese restaurants are displayed on the road map.

In this way, in this example, by the Japanese food button 43 positioned at a deep level being touched, the Japanese food restaurant position display function for displaying the positions of Japanese food restaurants on the road map is set on, the Japanese food restaurant position display function is activated, and the positions of Japanese food restaurants are displayed on the road map. In this case, for example, when the positions of Japanese food restaurants are displayed on the road map, if the button 31 for navigation function use is touched, the Japanese food restaurant position display function is set off and the display of the positions of the Japanese food restaurants disappears from this road map. Note that the road map screen, display changing screen, surrounding facility selection screen, and restaurant selection screen respectively shown in FIGS. 3A, 4A, 4B, and 5 usually display a plurality of other buttons, but FIGS. 3A, 4A, 4B, and 5 omit display of these plurality of other buttons.

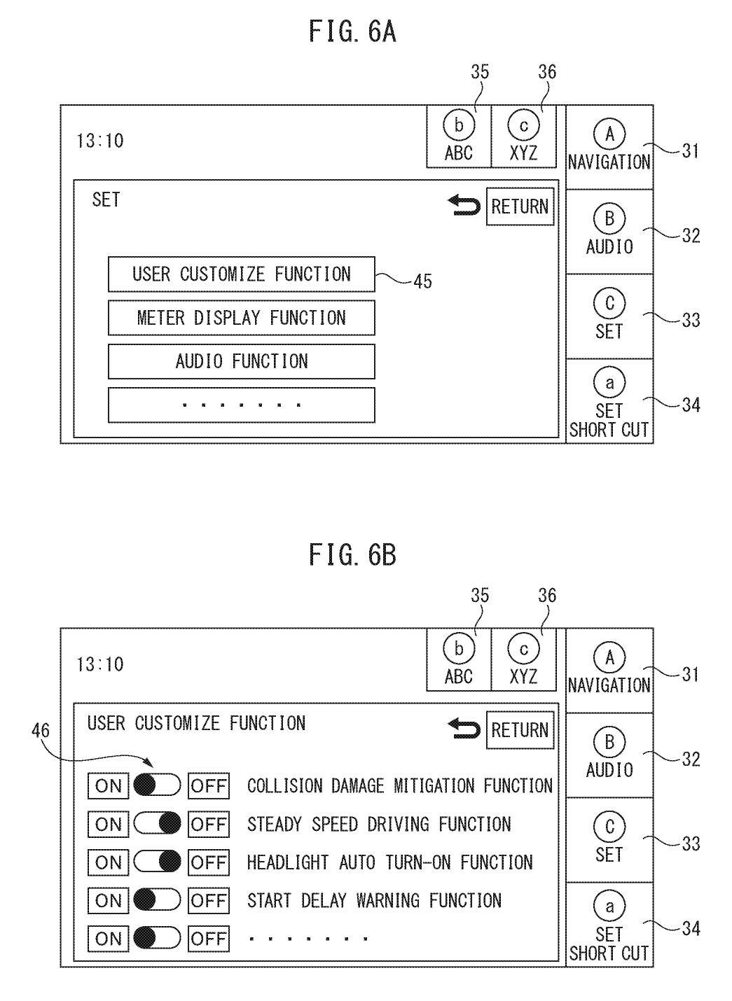

On the other hand, when, for example, the road map is displayed on the basic screen of the display device 21 such as shown in FIG. 3A, if the setting button 33 is touched, the road map is switched to a setting screen such as shown in FIG. 6A positioned one level lower. Next, if, for example, a user customize function button 45 displayed on this setting screen is touched, the setting screen is switched to a user customize function selection screen such as shown in FIG. 6B positioned one further level lower. In the example shown in FIG. 6B, an on-off display 46 is displayed on the user customize function selection screen for showing whether respective functions are currently on or off.

Here, if simply explaining the functions displayed on the user customize function selection screen, a collision damage mitigating function is a function of using the braking device 11 to impart a braking force to the vehicle 1 when a state where the vehicle 1 approaches another vehicle from the rear is detected by the detection device 18, a steady speed driving function is a function of making the vehicle 1 run at a steady speed which is set, a headlight auto turn-on function is a function of automatically turning on the headlights when the brightness of the surroundings becomes a threshold value or less, and a start delay warning function is a function of issuing a warning when for example the vehicle 1 continues to be stopped despite another vehicle stopped in front of the vehicle 1 starting to move. Note that, in FIGS. 6A and 6B, the expression “…….” means there is a description, but details of the description are omitted. The same is true below.

That is, the functions described in FIG. 6B are just part of the functions listed on the user customize function selection screen. In actuality, the user customize function selection screen displays a far greater number of functions. In FIG. 6B, for example, if focusing on the headlight auto turn-on function, currently the headlight auto turn-on function is deactivated as will be understood from the on/off display 46. That is, the headlight auto turn-on function is set off. In this case, if touching the ON button of the headlight auto turn-on function, the headlight auto turn-on function changes from the off setting to the on setting and the on/off display 46 changes to show an on setting. In this way, in this example, by touching the corresponding button on the user customize function selection screen positioned at the deepest level, it is possible to switch all of the functions from the off setting to the on setting or switch them from the on setting to the off setting.

In this way, the buttons for setting functions on or setting them off are positioned at the deep level. However, in this way, if the buttons are positioned at the deep level, time is taken for operating the buttons. In particular, if the buttons of functions often utilized by a user are positioned at the deep level, for the user, operation of the button becomes considerably burdensome. Therefore, to lighten the burden on the user, in an embodiment according to the present disclosure, as shown in FIG. 3A, two short cut buttons 35, 36 for operation to which respectively different functions are assigned are displayed on the basic screen of the display device 21. Of course, three or more of such short cut buttons can also be displayed, but below, an embodiment according to the present disclosure will be explained with reference to an example of a case where two short cut buttons 35, 36 are displayed. Note that, in FIG. 3A, the marks “b”, “c” and letters ABC, XYZ schematically show icons.

In an embodiment according to the present disclosure, if touching the short cut button 35, when the function assigned to the short cut button 35 is currently set off, it is switched to an on setting. Due to this, the function assigned to the short cut button 35 is activated. Next, if touching the short cut button 35 one more time, the function assigned to the short cut button 35 is switched from the on setting to the off setting whereupon the function assigned to the short cut button 35 is deactivated. That is, each time touching the short cut button 35, the on setting and off setting of the function are switched whereupon activation of the function and deactivation of the function are switched.

Similarly, if touching the short cut button 36, when the function assigned to the short cut button 36 is currently set off, it is switched to an on setting. Due to this, the function assigned to the short cut button 36 is activated. Next, if touching the short cut button 36 one more time, the function assigned to the short cut button 36 is switched from the on setting to the off setting whereupon the function assigned to the short cut button 36 is deactivated. That is, each time touching the short cut button 36, the on setting and off setting of the function are switched whereupon activation of the function and deactivation of the function are switched.

Further, in an embodiment according to the present disclosure, if touching the short cut button 35, when the function assigned to the short cut button 35 is set off, the short cut button 35 is rendered off in display, while if the function assigned to the short cut button 35 is set on, the short cut button 35 is rendered on in display. Similarly, when the function assigned to the short cut button 36 is set off, the short cut button 36 is rendered off in display, while if the function assigned to the short cut button 36 is set on, the short cut button 36 is rendered on in display.

An example when the short cut button 35 is rendered off in display and when the short cut button 35 is rendered on in display is shown in FIGS. 3A and 3B. In this example, when the short cut button 35 is the same brightness as the other buttons 31, 32, and 33 as shown in FIG. 3A, the display of the short cut button 35 is deemed off in display while when the short cut button 35 as a whole shines brightly or when the icon part of the short cut button 35 shines brightly as shown in FIG. 3B, the short cut button 35 is deemed on in display. Similarly, when the short cut button 36 is the same brightness as the other buttons 31, 32, and 33, the short cut button 36 is deemed off in display, while when the short cut button 36 as a whole shines brightly or when the icon part of the short cut button 36 shines brightly, the short cut button 36 is deemed on in display.

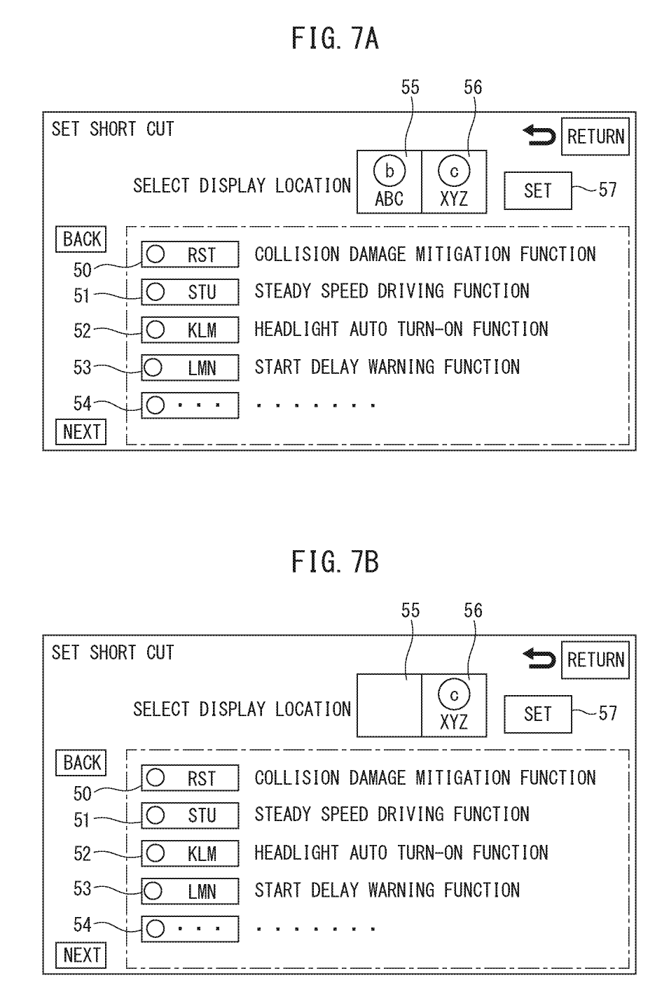

Further, in an embodiment according to the present disclosure, to assign functions to the short cut buttons 35, 36, as shown in FIGS. 3A and 3B, a short cut setting button 34 is displayed on the basic screen of the display device 21. In this case, for example, if the short cut setting button 34 is touched when the road map is displayed on the basic screen of the display device 21 as shown in FIG. 3A, the road map is switched to a short cut setting screen positioned at one lower level such as shown in FIG. 7A. In the example shown in FIG. 7A, candidates of functions able to be assigned to the short cut buttons 35, 36 are displayed on the short cut setting screen. Furthermore, for the candidates of the functions displayed, the short cut setting buttons 50, 51, 52, 53, and 54 are respectively displayed. Icons comprised of marks and letters are displayed on the short cut setting buttons 50, 51, 52, 53, and 54.

Note that, the candidates of the functions shown in FIG. 7A, that is, the collision damage mitigation function, the steady speed driving function, the headlight auto turn-on function, and the start delay warning function are just some of the candidates of functions listed on the short cut setting screen. In actual, a far greater number of the candidates of functions are displayed on the short cut setting screen. In this case, in the example shown in FIG. 7A, numerous candidates of functions are displayed over several pages. Further, in the example shown in FIG. 7A, the short cut setting buttons 50, 51, 52, 53, 54 of the candidates of functions which are set on, that is, the candidates of the functions which are activated are rendered on in display, and the short cut setting buttons 50, 51, 52, 53, 54 of the candidates of functions which are set on shine brightly at the short cut setting buttons 50, 51, 52, 53, 54 as a whole or the icon parts. The functions to be assigned to the short cut buttons 35, 36 displayed on the basic screen of the display device 21 can be selected by the user of the vehicle 1 from among the candidates of functions listed on this short cut setting screen.

Further, in the example shown in FIG. 7A, display location selection buttons 55 and 56 for selecting one of the two short cut buttons 35, 36 displayed on the basic screen of the display device 21 to which the function selected by the user of the vehicle 1 should be assigned are displayed on the short cut setting screen. In this case, the display location selection buttons 55 and 56 are provided so that it is understood that the short cut button 35 displayed on the basic screen of the display device 21 corresponds to the display location selection button 55 displayed on the short cut setting screen while the short cut button 36 displayed on the basic screen of the display device 21 corresponds to the display location selection button 56 displayed on the short cut setting screen. In this case, in the example shown in FIG. 7A, the short cut button 35 and the display location selection button 55 are displayed by the same icon while the short cut button 36 and the display location selection button 56 are displayed by the same icon. In this case, if no function is assigned to, for example, the short cut button 35, as will be understood from FIG. 7B, no icon is displayed at the display location selection button 55.

For example, when the user of the vehicle 1 desires to assign the headlight auto turn-on function to the short cut button 35, if the user touches the short cut setting button 52 of the headlight auto turn-on function, then touches the display location selection button 55, then touches the setting button 57, the headlight auto turn-on function is assigned to the short cut button 35. If the headlight auto turn-on function is assigned to the short cut button 35, the display and icon of the function which had been assigned to the short cut button 35 up to then are returned to the short cut setting screen and an icon showing the headlight auto turn-on function is displayed on the short cut button 35. If the headlight auto turn-on function finishes being assigned to the short cut button 35, after that, it becomes possible to switch between the on setting and off setting of the headlight auto turn-on function by just touching the short cut button 35 displayed on the basic screen of the display device 21.

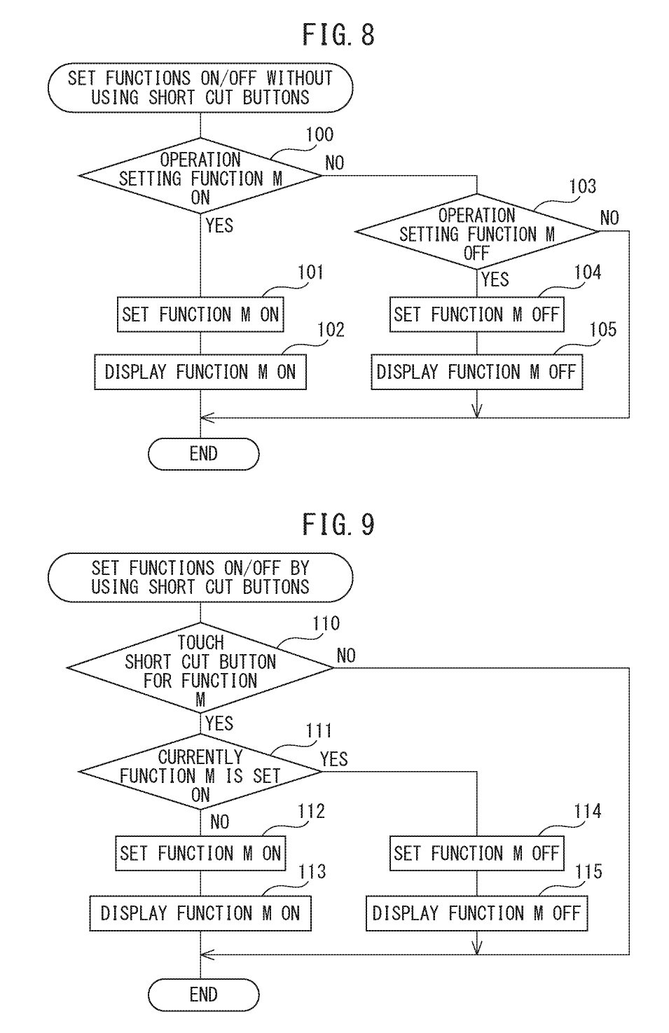

Next, referring to FIGS. 8 and 9, the routine for performing processing for setting functions on/off without using the short cut buttons 35, 36 and the routine for performing processing for setting functions on/off by using the short cut buttons 35, 36 will be successively explained. FIG. 8 shows a flow chart for performing processing for setting functions on/off without using short cut buttons 35, 36, and FIG. 9 shows a flow chart for performing processing for setting functions on/off by using short cut buttons 35, 36. The routines shown in FIGS. 8 and 9 are provided for each function and these routines are repeatedly performed in the electronic control unit 13. Note that, a program for performing each function is stored in advance in the memory 16 of the electronic control unit 13.

Referring to FIG. 8 showing the routine for performing the processing for setting functions on/off without using the short cut buttons 35, 36, first, at step 100, it is judged whether an operation requesting activation of the function M, that is, an operation for setting the function M on has been performed by the user. For example, when the user touches the Japanese food restaurant button 43 in FIG. 5, it is judged that an operation requesting activation of the Japanese food restaurant position display function for displaying positions of Japanese food restaurants on the road map has been performed, that is, an operation for setting the Japanese food restaurant position display function on has been performed. In this case, the function M indicates the Japanese food restaurant position display function. Further, when the user touches the ON button of the headlight auto turn-on function in FIG. 6B, it is judged that an operation requesting activation of the headlight auto turn-on function for making the headlights automatically turn on when the brightness of the surroundings becomes a threshold value or less has been performed, that is, an operation for setting the headlight auto turn-on function on has been performed. In this case, the function M indicates the headlight auto turn-on function.

When, at step 100, it is judged that an operation requesting activation of the function M, that is, an operation for setting the function M on has been performed by the user, the routine proceeds to step 101 where the function M is set on and the function M is activated. At this time, if the function M is the Japanese food restaurant position display function, the Japanese food restaurant position display function for displaying positions of Japanese food restaurants on the road map is performed, while if the function M is the headlight auto turn-on function, the headlight auto turn-on function for making the headlights automatically turn on is performed. If the function M is set on, as shown at step 102, the function M is rendered on in display. At this time, the on/off display switch 46 of the function M shown in FIG. 6B is switched from “display off” to “display on” while the short cut setting button of the candidates of the function M shown in FIG. 7A etc. is switched from “display off” to “display on”. If the short cut button for the function M is being displayed, the short cut button for the function M is switched from an “display off” to “display on”.

As opposed to this, when at step 100, it is judged that an operation requesting activation of the function M, that is, an operation for setting the function M on has not been performed by the user, the routine proceeds to step 103 where it is judged whether an operation for deactivation of the function M, that is, an operation for setting the function M off has been performed by the user. For example, when the positions of Japanese food restaurants are displayed on the road map, if the user touches the button 31 of the navigation function, it is judged that an operation for deactivation of the Japanese food restaurant position display function, that is, an operation for setting the Japanese food restaurant position display function off has been performed. In this case, the “function M” indicates the Japanese food restaurant position display function. Further, when the user touches the OFF button of the headlight auto turn-on function in FIG. 5B, it is judged that an operation for stopping activation of the headlight auto turn-on function has been performed, that is, an operation for setting the headlight auto turn-on function off has been performed. In this case, the “function M” indicates the headlight auto turn-on function.

When at step 103, it is judged that an operation for deactivation of the function M, that is, an operating for setting the function M off has been performed by the user, the routine proceeds to step 104 where the function M is set off and the function M is deactivated. At this time, if the function M is the Japanese food restaurant position display function, display of the positions of Japanese food restaurants on the road map is stopped, and if the function M is the headlight auto turn-on function, the headlight auto turn-on function for making the headlights automatically turn on is deactivated. If the function M is set off, as shown in step 105, the function M is rendered off in display. At this time, the on/off display switch 46 for the function M shown in FIG. 6B is switched from “display on” to “display off” while the short cut setting button of the candidates of the function M shown in FIG. 7A etc. is switched from “display on” to “display off”. If the short cut button for the function M is displayed, the short cut button for the function M is switched from “display on” to “display off”. On the other hand, if, at step 103, it is judged that an operation for setting the function M off has not been performed by the user, the processing cycle is ended.

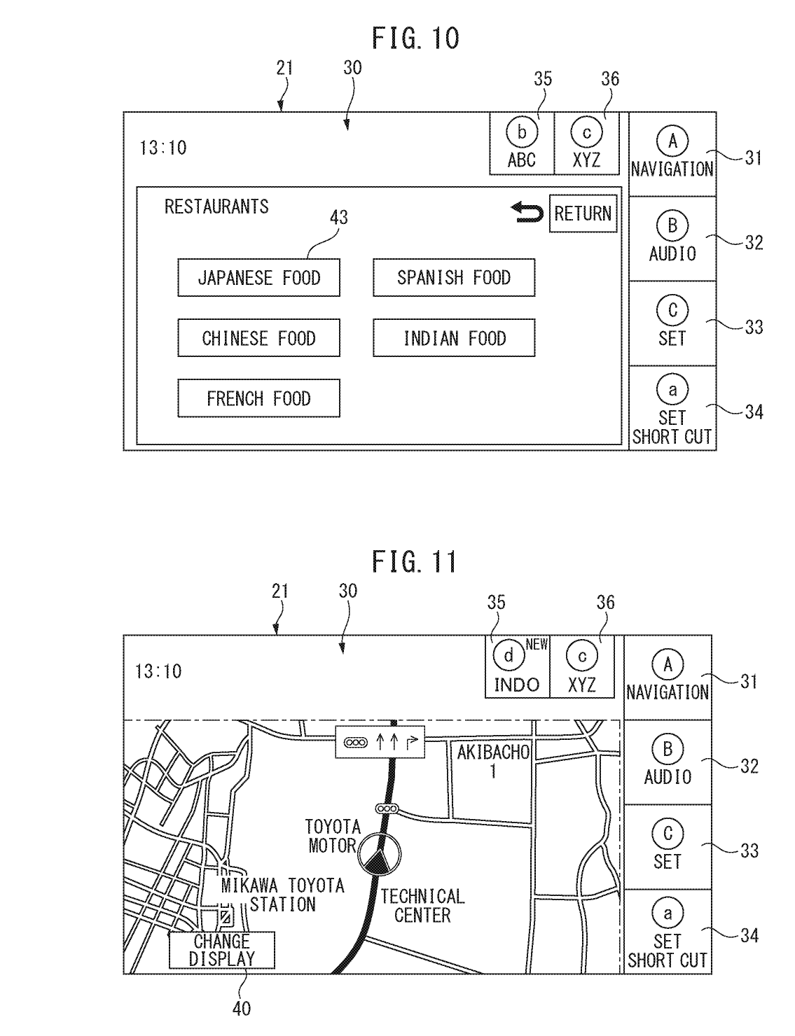

FIG. 9 shows a routine for performing processing for setting functions on/off by using the short cut buttons 35, 36. If explaining FIG. 10 with reference to the example of the case where the function M is assigned to one of the short cut buttons 35, 36, for example, the short cut button 35, first, at step 110, it is judged whether the short cut button 35 to which the function M has been assigned has been touched. When it is judged that the short cut button 35 has been touched, the routine proceeds to step 111 where it is judged whether currently the function M is set on, that is, whether the function M is activated. When it is judged that the function M is set off, that is, when it is judged that function M is deactivated, the routine proceeds to step 112.

At step 112, the function M is set on and the function M is activated. At this time, if the function M is the Japanese food restaurant position display function, the Japanese food restaurant position display function for displaying the positions of Japanese food restaurants on the road map is performed, while in the case where the function M is the headlight auto turn-on function, the headlight auto turn-on function for making the headlights automatically turn on is performed. If the function M is set on, as shown at step 113, the function M is rendered on in display. At this time, the short cut setting button of the candidates for the function M shown in FIG. 7A etc. is switched from “display off” to “display on”, the on/off display switch 46 of the function M shown in FIG. 6B is switched from “display off” to “display on”, and the short cut button 35 is switched from “display off” to “display on”.

On the other hand, when, at step 111, it is judged that the function M is currently set on, that is, the function M is activated, the routine proceeds to step 114 where the function M is set off and the function M is deactivated. At this time, if the function M is the Japanese food restaurant position display function, the display of the positions of Japanese food restaurants on the road map is stopped, while if the function M is the headlight auto turn-on function, the headlight auto turn-on function for making the headlights automatically turn on is deactivated.

If the function M is set off, as shown at step 115, the function M is rendered off in display. At this time, the short cut setting button of the candidates of the function M shown in FIG. 7A etc. is switched from “display on” to “display off”, the on/off display switch 46 of the function M shown in FIG. 6B is switched from “display on” to “display off”, and the short cut button 35 is switched from “display on” to “display off”. On the other hand, when at step 110, it is judged that the short cut button 35 has not been touched, the processing cycle is ended.

In this way, in an embodiment according to the present disclosure, the short cut buttons 35, 36 are displayed on the basic screen of the display device 21, and it is possible to set the functions respectively assigned to the short cut buttons 35, 36 on/off by just touching the short cut buttons 35, 36. Therefore, it is possible to lessen the burden felt by the user when setting the functions on/off. Here, the issue becomes which functions should be assigned to the short cut buttons 35, 36 to enable the burden felt by the user to be more effectively lessened. Therefore, next, the functions desirably assigned to the short cut buttons 35, 36 will be studied.

Now then, assume that, in the past, as shown in FIG. 5, the Japanese food button 43, the Chinese food button, the French food button, and the Spanish food button were displayed on the restaurant selection screen. In this case, for example, if the Japanese food button 43 is touched, the restaurant selection screen is switched to the road map screen shown in FIG. 3A and the positions of Japanese restaurants are displayed on the road map. On the other hand, assume that when in such a state, a position display function newly enabling the display of the positions of Indian restaurants, that is, an Indian restaurant position display function enabling the display of the positions of Indian restaurants on the road map was developed and that, as shown in FIG. 10, a new selection screen in which an Indian food button is displayed in addition to the Japanese food button 43, the Chinese food button, the French food button, and the Spanish food button was prepared.

In this case, in an embodiment according to the present disclosure, information relating to these functions, including the program for performing the Indian restaurant position display function, and information relating to the restaurant selection screen shown in FIG. 10 are, for example, sent from an information center as addition information of the new function or update information of the existing function and the information sent from the information center is received by each vehicle 1. At this time, among the users of the vehicles 1, there will be users desiring to immediately utilize these added new function or updated existing function. For such users, it may be considered desirable that the short cut buttons for these added new function or updated existing function be immediately displayed.

Therefore, in an embodiment according to the present disclosure, when receiving addition information of the new function or update information of the existing function, the added new function or the updated existing function is assigned to either of the short cut buttons 35, 36 and the short cut buttons 35, 36 to which the added new function or the updated existing function is assigned is displayed on the basic screen of the display device 21. For example, when receiving addition information of the Indian restaurant position display function, the added Indian restaurant position display function is assigned to the short cut button 35 and, as shown in FIG. 11, the short cut button 35 to which the Indian restaurant position display function is assigned is displayed on the basic screen of the display device 21.

In this way, if the added new function or the updated existing function is assigned to the short cut button 35, by just touching the short cut button 35, it becomes possible to switch the added new function or the updated existing function from the off setting to the on setting or from the on setting to the off setting and therefore becomes possible to lighten the burden felt by the user. Note that once assigning the added new function or the updated existing function to the short cut button 35, after that, each time the power of the vehicle 1 is turned on, the added new function or the updated existing function will automatically be assigned to the short cut button 35. Therefore, each time the power of the vehicle 1 is turned on, by just touching the short cut button 35, it becomes possible to switch the added new function or the updated existing function from the off setting to the on setting or from the on setting to the off setting.

Now then, as explained above, in an embodiment according to the present disclosure, when the new function is developed or a program for updating the updated existing function etc. is developed, information relating to these functions is sent from for example the information center as addition information of the new function or update information of the existing function. The addition information of the new function or the update information of the existing function sent from the information center is received by each vehicle 1.

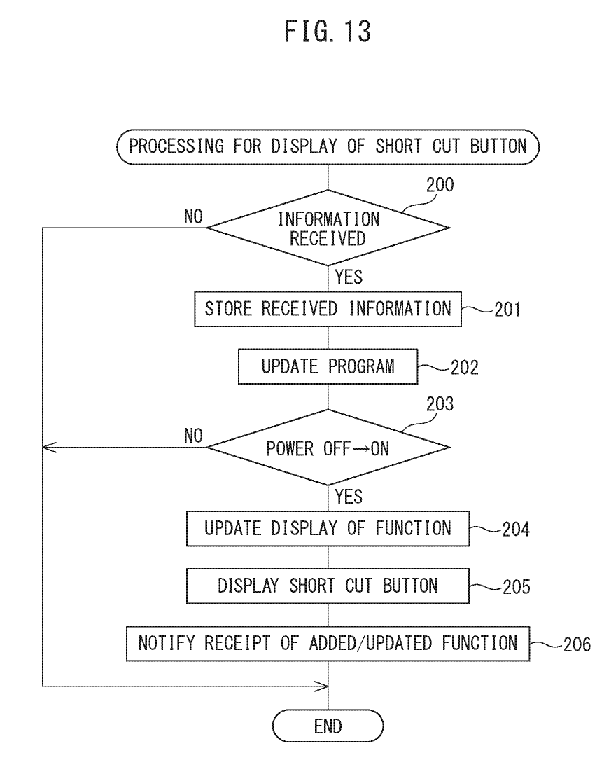

FIG. 13 shows a routine for performing processing for display of a short cut button based on such addition/update information of the function. This routine is repeatedly performed in the electronic control unit 13 of each vehicle 1.

Referring to FIG. 13, first, at step 200, it is judged if addition information of the new function or update information of the existing function sent from the information center has been received. When it is judged that such information has not been received, the processing cycle ends. As opposed to this, when it is judged that such information has been received, the routine proceeds to step 201 where the received data relating to the information is stored in the memory 16 in the electronic control unit 13. Next, at step 202, the program stored in the memory 16 is updated based on this received data. Next, at step 203, it is judged whether the power of the vehicle 1 is switched from off to on, that is, whether the power is turned on. When it is judged that the power is not turned on, the processing cycle ends.

As opposed to this, when at step 203 it is judged that the power is turned on, the routine proceeds to step 204 where the display of the function is updated. For example, the restaurant selection screen is changed from the restaurant selection screen shown in FIG. 5 to the restaurant selection screen shown in FIG. 10. Next, at step 205, the added new function or the updated existing function is assigned to either of the short cut buttons 35, 36, for example, the short cut button 35, and the short cut button 35 to which the added new function or the updated existing function is assigned is displayed on the basic screen of the display device 21. For example, when receiving addition information of the Indian restaurant position display function, the added Indian restaurant position display function is assigned to either of the short cut buttons 35, 36, for example, the short cut button 35, and, as shown in FIG. 11, the short cut button 35 to which the Indian restaurant position display function is assigned is displayed on the basic screen of the display device 21.

Next, at step 206, the user of the vehicle 1 is notified of the fact of receiving the added/updated function. This notification is performed by displaying the fact of reception of the added/updated function on the basic screen of the display device 21 when the power is turned on.

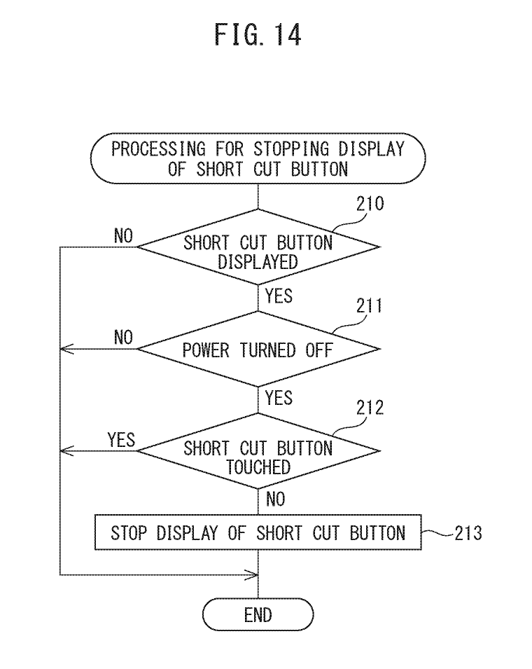

FIG. 14 shows a routine for stopping the display of the short cut button 35 on the basic screen of the display device 21 after the short cut button 35 for the added new function or the updated existing function is displayed. The routine for performing processing for stopping the display of the short cut button shown in this FIG. 14 is repeatedly performed in the electronic control unit 13 of each vehicle 1.

Referring to FIG. 14, first, at step 210, it is judged if the short cut button 35 for the added new function or the updated existing function is displayed. When it is judged that the short cut button 35 for the added new function or the updated existing function is not displayed, the processing cycle is ended. As opposed to this, when it is judged that the short cut button 35 for the added new function or the updated existing function is displayed, the routine proceeds to step 211.

At step 211, it is judged whether the power is turned off, that is, if the power is switched from on to off. When it is judged that the power is not turned off, the processing cycle is ended. As opposed to this, when it is judged that the power is turned off, the routine proceeds to step 212 where it is judged if the short cut button 35 for the added new function or the updated existing function has been touched after the short cut button 35 for the added new function or the updated existing function was displayed, that is, during the time from when the power was turned on to when the power is turned off. When it is judged that the short cut button 35 for the added new function or the updated existing function has been touched during the time from when the power was turned on to when the power is turned off, the processing cycle ends.

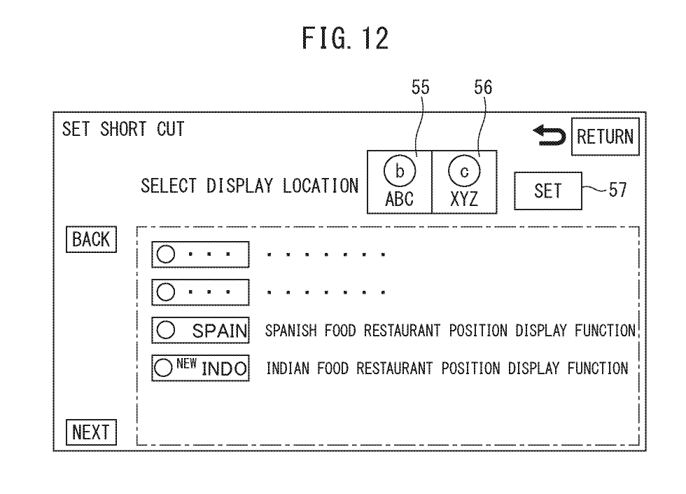

As opposed to this, when it is judged that the short cut button 35 for the added new function or the updated existing function has not been touched during the time from when the power was turned on to when the power is turned off, the routine proceeds to step 213 where the display of the short cut button 35 for the added new function or the updated existing function on the basic screen of the display device 21 is stopped. At this time, the function which had been assigned to the short cut button 35, for example, the Indian restaurant position display function is displayed on the last page of the short cut setting screen as shown in FIG. 12.

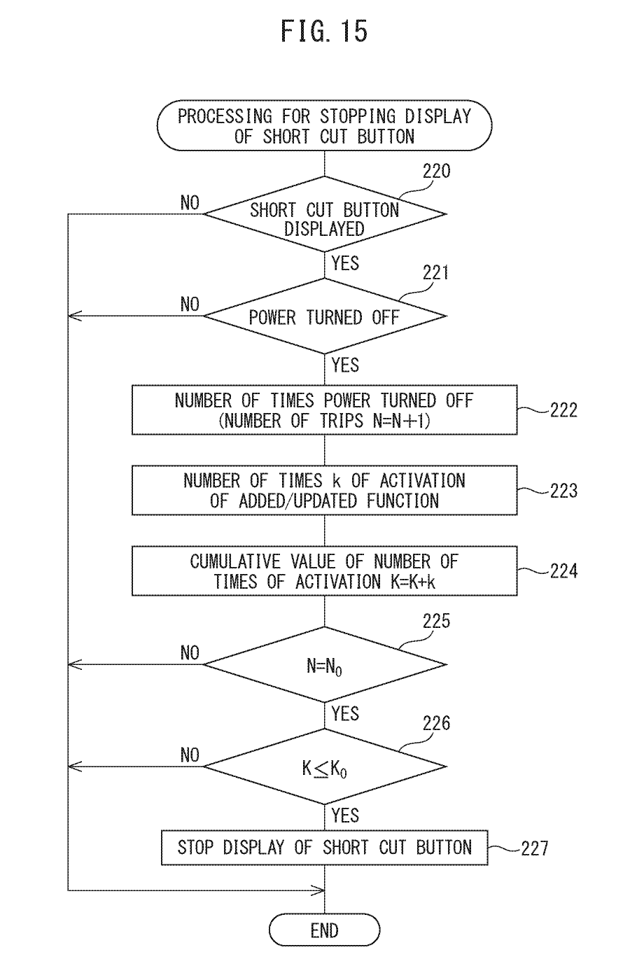

FIG. 15 shows another routine for stopping the display of the short cut button 35 on the basic screen of the display device 21 after the short cut button 35 for the added new function or the updated existing function is displayed on the basic screen of the display device 21. The routine for executing processing for stopping the display of the short cut button 35 shown in this FIG. 15 is repeatedly executed in the electronic control unit 13 of each vehicle 1.

Referring to FIG. 15, first, at step 220, it is judged if the short cut button 35 for the added new function or the updated existing function is displayed. When it is judged that the short cut button 35 for the added new function or the updated existing function is not displayed, the processing cycle is ended. As opposed to this, when it is judged that the short cut button 35 for the added new function or the updated existing function is displayed, the routine proceeds to step 221.

At step 221, it is judged if the power is turned off or not, that is, if the power is switched from on to off. When it judged that the power is not turned off, the processing cycle is ended. As opposed to this, when it is judged that the power is turned off, the routine proceeds to step 222 where the number of times N the power was turned off is increased by 1. Here, the period from when the power is turned on to when the power is turned off is called “1 trip”, so this N expresses the number of trips. Next, at step 223, the number of times of activation of the added new function or the updated existing function during the time from when the power is turned on to when the power is turned off is made “k”. Next, at step 224, the cumulative value of this number of times of activation “k” is made K. Next, the routine proceeds to step 225.

At step 225, it is judged if the number of trips N has reached the set number of trips N₀. When it is judged if the number of trips N has not reached the set number of trips N₀, the processing cycle ends. As opposed to this, when it is judged that the number of trips N has reached the set number of trips N₀, the routine proceeds to step 226 where it is judged whether the cumulative value K of the number of times of activation of the added new function or the updated existing function is the set cumulative value K₀ or less. When it is judged the cumulative value K of the number of times of activation is not the set cumulative value K₀ or less, the processing cycle ends. As opposed to this, when it is judged the cumulative value K of the number of times of activation of the added new function or the updated existing function is the set cumulative value K₀ or less, the routine proceeds to step 227 where the display of the short cut button 35 for the added new function or the updated existing function on the basic screen of the display device 21 is stopped. At this time, the function which had been assigned to the short cut button 35, for example, the Indian restaurant position display function is displayed on the last page of the short cut setting screen such as shown in FIG. 12.

In this way, in the example shown in FIG. 15, when it is judged that the number N of trips has reached the set number N₀ of trips and it is judged that the cumulative value K of the number of times of activation is the set cumulative value K₀ or less, the display of the short cut button 35 for the added new function or the updated existing function is stopped. In this case, when the set number N₀ of trips is a whole number of 2 or more, for example, when the set number N₀ of trips is 5 and the set cumulative value K₀ is zero, if the added new function or the updated existing function was not activated from when the short cut button 35 was displayed to when 5 trips passed, the display of the short cut button 35 is stopped. Further, when the set cumulative value K₀ is made a whole number, if the frequency of activation of the added new function or the updated existing function in the period up to when the number N of trips reaches the set number N₀ of trips is a set frequency of activation or less, the display of the short cut button 35 is stopped.

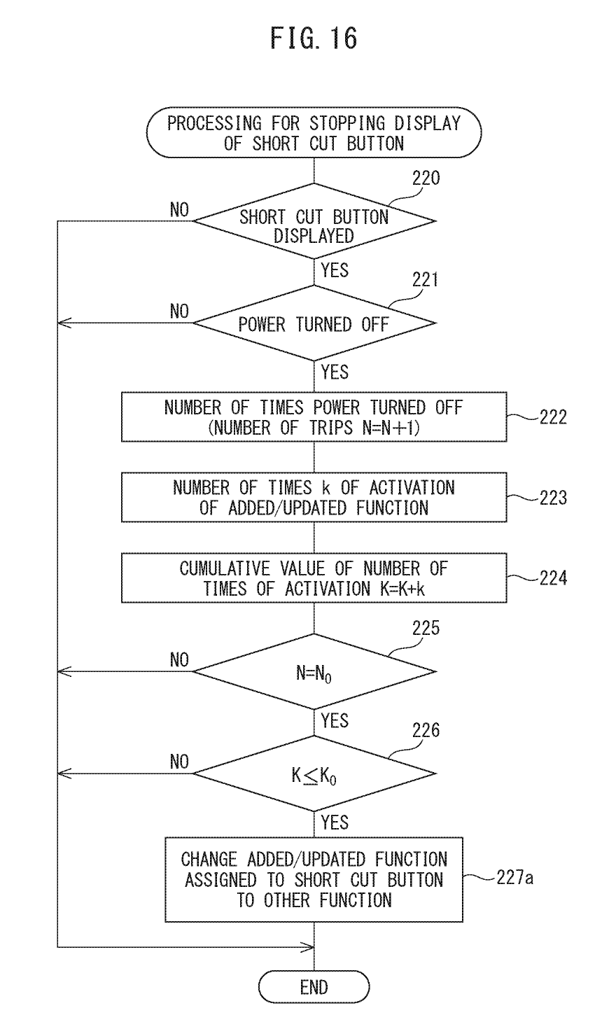

FIG. 16 shows a routine for performing another example of the processing for stopping display of a short cut button shown in FIG. 15. This routine is also repeatedly performed in an electronic control unit 13.

In the routine shown in FIG. 16, step 220 to step 226 are the same as step 220 to step 226 in the routine shown in FIG. 15. The routine shown in FIG. 16 differs from the routine shown in FIG. 15 only on step 227a in FIG. 16. Therefore, in the routine shown in FIG. 16, explanation of step 220 to step 226 will be omitted and only step 227a in FIG. 16 will be explained.

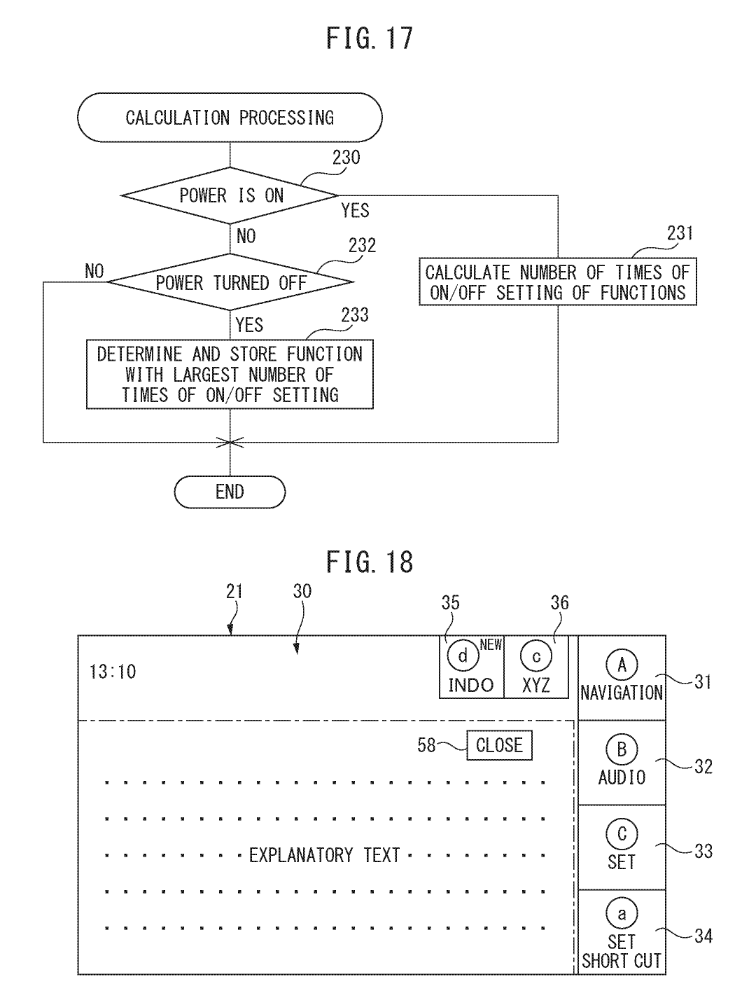

In the example shown in FIG. 16, in step 227a, the function assigned to the short cut button 35 is changed from the added new function or the updated existing function to another function and, instead of the short cut button 35 to which the added new function or the updated existing function is assigned, the short cut button 35 to which another function is assigned is displayed. This other function is for example made a function with a high frequency of use. In this way, if making this other function a function with a high frequency of use, it becomes necessary to calculate the frequency of use of the function. FIG. 17 shows a calculation processing routine for calculating the frequency of use of a function. This routine is repeatedly performed in an electronic control unit 13.

Referring to FIG. 17, first, at step 230, it is judged whether the power of the vehicle 1 is on. When it is judged that the power of the vehicle 1 is on, the routine proceeds to step 231 where, for each function, the total number of the number of times the function was switched from the on setting to the off setting and the number of times the function was switched from the off setting to the on setting, that is, the number of times of on/off setting of the function is calculated. On the other hand, when at step 230 it is judged that the power of the vehicle 1 is off, the routine proceeds to step 232 where it is judged if the power of the vehicle 1 has just now been switched from on to off, that is, if the power of the vehicle 1 is turned off. When it is judged that the power of the vehicle 1 is turned off, the routine proceeds to step 233 where among the times of on/off settings calculated at step 131, the function with the greatest number of times of on/off settings is determined and stored in the memory 16. The function with the greatest number of times of on/off settings is made the function with a high frequency of use.

In this way, in an embodiment according to the present disclosure, when receiving addition information of the new functions or update information of the existing functions, the short cut buttons 35, 36 for these added new functions or updated existing functions are displayed on the basic screen of the display device 21. In this case, there is a possibility that the user would not know of the added contents of the new functions or the updated contents of the existing functions. Therefore, in another embodiment according to the present disclosure, when the user first touches the short cut buttons 35, 36 for the added new functions or the updated existing functions after the short cut buttons 35, 36 for the added new functions or the updated existing functions are displayed on the basic screen of the display device 21, as shown in FIG. 18, an explanatory text relating to the added new functions or the updated existing functions is displayed on the basic screen of the display device 21.

In this case, in the example shown in FIG. 18, by a close button 58 shown in FIG. 18 being touched, the screen displaying the explanatory text is switched to the original screen, that is, the basic screen shown in FIG. 3A. Note that, in this case, the explanation relating to the added new function or the updated existing function may be provided by voice. Therefore, comprehensively speaking, when the short cut buttons 35, 36 for the added new functions or the updated existing functions are displayed on the basic screen of the display device 21, then the user first touches the short cut buttons 35, 36 for the added new functions or the updated existing functions, an overview of the added new functions or the updated existing functions is explained.

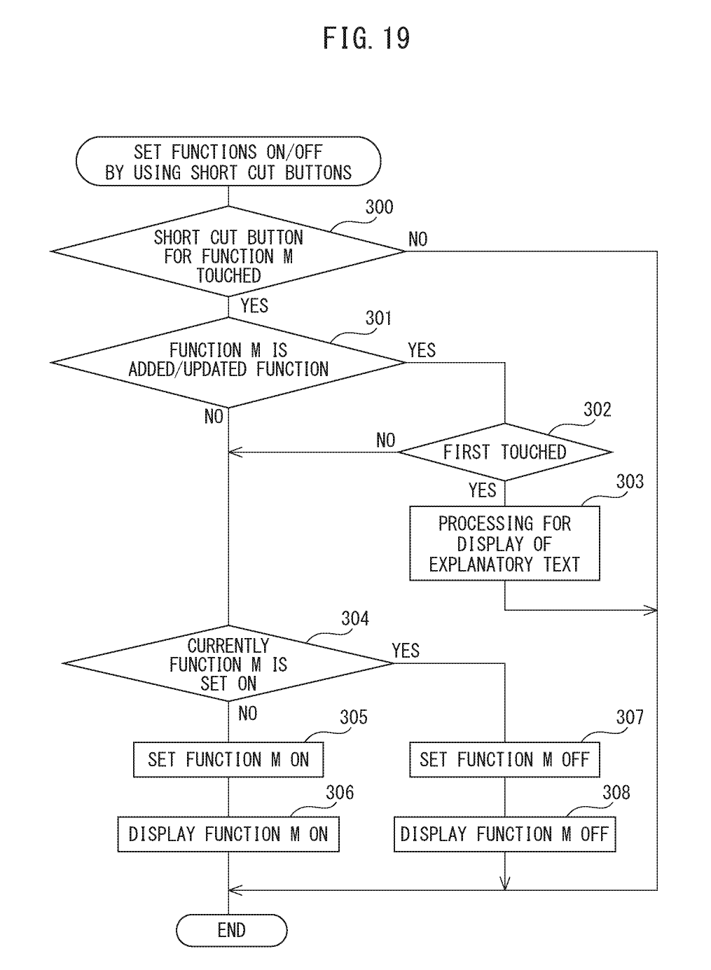

In this another embodiment according to the present disclosure, instead of the routine for performing processing for on/off setting of functions by using the short cut buttons 35, 36 shown in FIG. 9, a routine for performing processing for on/off setting of functions by using the short cut buttons 35, 36 shown in FIG. 19 is used. Explaining FIG. 19 taking as an example the case where a function M is assigned to one of the short cut buttons 35, 36, for example, the short cut button 35, first, at step 300, it is judged whether the short cut button 35 to which the function M is assigned is touched. When it is judged that the short cut button 35 is touched, the routine proceeds to step 301 where it is judged if the function M assigned to the short cut button 35 is the added new function or the updated existing function. That is it is judged by step 300 and step 301 whether the short cut button 35 for the added new function or the updated existing function is touched.

When, at step 301, it is judged that the function M assigned to the short cut button 35 is the added new function or the updated existing function, that is, when the short cut button 35 for the added new function or the updated existing function is touched, the routine proceeds to step 302 where it is judged if the short cut button 35 for the added new function or the updated existing function is touched first after being displayed on the basic screen of the display device 21. When it is judged that the short cut button 35 is first touched, the routine proceeds to step 303 where, as shown in FIG. 18, the explanatory text relating to the added new function or the updated existing function is displayed on the basic screen of the display device 21. Next, the processing cycle is ended.

On the other hand, when at step 301 it is judged that the function M which is assigned to the short cut button 35 is not the added new function or the updated existing function, that is, when the short cut button 35 for the function M which is not the added new function or the updated existing function is touched, the routine proceeds to step 304. Further, the routine also proceeds to step 304 even when it is judged at step 301 that the short cut button 35 is not first touched. That is, when the short cut button 35 for the function which is not the added new function and the updated existing function is touched, the routine always proceeds to step 304, while when the short cut button 35 for the added new function or the updated existing function is touched, if not when touched first, the routine proceeds to step 304.

At step 304, it is judged whether the function M is currently set on, that is, whether the function M is activated. In this case, this function M includes both functions which are not the added new functions or the updated existing functions and are the added new functions and the updated existing functions. When at step 304 it is judged that the function M is set off, that is, when it is judged that the function M is stopped being activated, the routine proceeds to step 305. At step 305, the function M is set on and the function M is activated. At this time, if the function M is the Japanese restaurant position display function, the Japanese restaurant position display function displaying positions of Japanese restaurants on the road map is performed, while if the function M is the headlight auto turn-on function, the headlight auto turn-on function making the headlight automatically turn on is performed. If the function M is set on, as shown in step 306, the function M is rendered on in display. At this time, the short cut setting button of the candidate for the function M shown in FIG. 7A etc. is switched from the off display to the on display, while the on/off display 46 for the function M shown in FIG. 6B is switched from the off display to on display. Further, the short cut button 35 is switched from the off display to the on display.

On the other hand, at step 304, when it is judged that the function M is currently set on. that is, the function M is activated, the routine proceeds to step 307 where the function M is set off and the activation of the function M is stopped. At this time, if the function M is the Japanese restaurant position display function, the display of Japanese restaurant positions on the road map is stopped. If the function M is the headlight auto turn-on function, activation of the headlight auto turn-on function for making the headlight automatically turn on is stopped. If the function M is set off, as shown in step 308, the function M is rendered off in display. At this time, the short cut setting button of the candidate of the function M shown in FIG. 7A etc. is switched from the on display to the off display while the on/off display 46 for the function M shown in FIG. 6B is switched from the on display to the off display and the short cut button 35 is switched from the on display to the off display. On the other hand, when, at step 300, it is judged that the short cut button 35 is not touched, the processing cycle ends.

In this way, in an embodiment according to the present disclosure, in a display control device for controlling a screen display of the display device 21 mounted in the vehicle 1, the display control device comprise a short cut button display control unit for making the short cut buttons 35, 36 be displayed on a basic screen of the display device 21. The short cut button display control unit makes the short cut button 35, 36 to which the added new function or the updated existing function is assigned be displayed on the basic screen of the display device 21 when acquiring addition information of the new function or update information of the existing function.

Further, in an embodiment according to the present disclosure, there is provided a display control method for controlling a screen display of the display device 21 mounted in the vehicle 1, the display control method causing a computer to make the short cut buttons 35, 36 be displayed on a basic screen of the display device 21 and make the short cut buttons 35, 36 to which the added new function or the updated existing function is assigned be displayed on the basic screen of the display device 21 when acquiring addition information of the new function or update information of the existing function.

Further, in an embodiment according to the present disclosure, there is provided a program or a program product used for controlling a screen display of the display device 21 mounted in the vehicle 1, the program or the program product causing a computer to make the short cut buttons 35, 36 be displayed on a basic screen of the display device 21 and make the short cut buttons 35, 36 to which the added new function or the updated existing function is assigned be displayed on the basic screen of the display device 21 when acquiring addition information of the new function or update information of the existing function.

Further, in an embodiment according to the present disclosure, the short cut button display control unit makes the short cut button 35, 36 to which the added new function or the updated existing function is assigned be displayed on the basic screen of the display device 21 when the power of the vehicle is turned on and stops the display of the short cut button 35, 36 to which the added new function or the updated existing function is assigned when the added new function or the updated existing function has not been activated until the elapse of a predetermined time period after the power is turned on. In this case, in this embodiment, the above mentioned predetermined time period is a time period until the power is turned off after the power was turned on or the time period from after the power was turned on to when the number of trips reaches a set number of trips.

Further, in an embodiment according to the present disclosure, the short cut button display control unit makes the short cut button 35, 36 to which the added new function or the updated existing function is assigned be displayed on the basic screen of the display device 21 when the power of the vehicle 1 is turned on and stops the display of the short cut button 35, 36 to which the added new function or the updated existing function is assigned when the a frequency of activation of the new function added or the existing function updated in the time period until the power is turned off after the power is turned on or in the time period after the power is turned on until the number of trips reaches a set number of trips is a set frequency of activation or less.

Further, in an embodiment according to the present disclosure, the short cut button display control unit makes the short cut button 35, 36 to which another function is assigned be displayed on the basic screen of the display device 21 instead of the short cut button 35, 36 to which the added new function or the updated existing function has been assigned when stopping the display of the short cut button 35, 36 to which the added new function or the updated existing function has been assigned. In this case, in an embodiment according to the present disclosure, the function with a high frequency of use from when the power of the vehicle 1 is turned on to when the power is turned off is made the other function.

Further, in an embodiment according to the present disclosure, when the user first touches the short cut button 35, 36 for the added new function or the updated existing function after the short cut button 35, 36 for the added new function or the updated existing function is displayed on the basic screen of the display device 1, the explanation regarding an overview of the added new functions or the updated existing functions is performed. Further, in an embodiment according to the present disclosure, the short cut button 35, 36 is formed so as to be switched between an on setting and off setting of the function assigned to the short cut button 35, 36 each time the short cut button 35, 36 is touched.

1. A display control device for controlling a screen display of a display device mounted in a vehicle, the display control device comprising
a short cut button display control unit for making short cut buttons be displayed on a basic screen of the display device,
the short cut button display control unit making the short cut button to which an added new function or an updated existing function is assigned be displayed on the basic screen of the display device when acquiring addition information of the new function or update information of the existing function.

2. The display control device according to claim 1, wherein the short cut button display control unit makes the short cut button to which the added new function or the updated existing function is assigned be displayed on the basic screen of the display device when a power of the vehicle is turned on and stops the display of the short cut button to which the added new function or the updated existing function is assigned when the added new function or the updated existing function has not been activated until the elapse of a predetermined time period after the power is turned on.

3. The display control device according to claim 2,
wherein the predetermined time period is a time period until the power is turned off after the power was turned on or the time period from after the power was turned on to when the number of trips reaches a set number of trips.

4. The display control device according to claim 1,
wherein the short cut button display control unit makes the short cut button to which the added new function or the updated existing function is assigned be displayed on the basic screen of the display device when a power of the vehicle is turned on and stops the display of the short cut button to which the added new function or the updated existing function is assigned when the a frequency of activation of the new function added or the existing function updated in the time period until the power is turned off after the power is turned on or in the time period after the power is turned on until the number of trips reaches a set number of trips is a set frequency of activation or less.

5. The display control device according to claim 1,
wherein the short cut button display control unit makes the short cut button to which another function is assigned be displayed on the basic screen of the display device instead of the short cut button to which the added new function or the updated existing function has been assigned when stopping the display of the short cut button to which the added new function or the updated existing function has been assigned.

6. The display control device according to claim 5,
wherein the function with a high frequency of use from when a power of the vehicle is turned on to when the power is turned off is made the other function.

7. The display control device according to claim 1,
wherein when a user first touches the short cut button for the added new function or the updated existing function after the short cut button for the added new function or the updated existing function is displayed on the basic screen of the display device, an explanation regarding an overview of the added new functions or the updated existing functions is performed.

8. The display control device according to claim 1, wherein the short cut button is formed so as to be switched between an on setting and off setting of the function assigned to the short cut button each time the short cut button is touched.

9. A display control method for controlling a screen display of a display device mounted in a vehicle, the display control method causing a computer to
make short cut buttons be displayed on a basic screen of the display device and
make short cut buttons to which an added new function or an updated existing function is assigned be displayed on the basic screen of the display device when acquiring addition information of the new function or update information of the existing function.

10. A non-transitory computer-readable storage medium storing a program used for controlling a screen display of a display device mounted in a vehicle, the program causing a computer to
make short cut buttons be displayed on a basic screen of the display device and
make short cut buttons to which an added new function or an updated existing function is assigned be displayed on the basic screen of the display device when acquiring addition information of the new function or update information of the existing function.
